(19) United States
(12) Patent Application Publication
(10) Pub. No.: US 2005/0232610 A1
(43) Pub. Date: Oct. 20, 2005

(54) User automated content deletion

(75) Inventors: Robert A. Boger, Sioux City, IA (US); Afram A. Chamoun, Thousand Oaks, CA (US)

Correspondence Address: Gateway, Inc.;Attention: Mark Dickey, 610 Gateway Drive, MS Y-04, N. Sioux City, SD, 57049, US

(73) Assignee: Gateway, Inc.

(21) Appl. No.: 10/826,749

(22) Filed: Apr. 16, 2004

(51) Int. Cl. H04N 5/781

(52) U.S. Cl. 386/125; 386/126

(57) ABSTRACT

The present invention provides a method of efficient resource-allocation of space on the hard disk of a PVR by furnishing a viewer with an automated content deletion capacity. The system may maintain individual scene segments on the hard disk along with the associated database table. The database table may contain viewer preference information (viewed, skipped, or unviewed) and starting/ending address information for each scene segment. By consulting the database table, the system may know what scene segments would be played or skipped. Further, upon reception of the user's request, the system may update the database table, which results to have more available space on the hard disk. Thus, the system may utilize the hard disk space efficiently.

### FIELD OF THE INVENTION

The present invention relates generally to personal video recording devices, and specifically to a method for increasing available hard disk space of a personal video recording device by furnishing a viewer with an automated content deletion capacity.

### BACKGROUND OF THE INVENTION

Personal video recorders (PVR) are becoming extremely popular as more people want additional control of recording live broadcast programs. A PVR, also known as a digital video recorder (DVR), is a device that may digitize a live broadcast onto a hard disk and play it back immediately. A PVR may allow a viewer to edit unwanted scenes (containing violence, or the like) from live broadcasts. A PVR may be similar to a traditional Video Cassette Recorder (VCR) in many ways since it records, plays and pauses live broadcast programs. One of the fundamental differences is that a PVR may use an integrated hard disk for storage instead of using traditional video tapes. A PVR allocates certain portions of the hard drive to a buffer for live broadcasts, software (operating system), and a recording space for pre-recorded broadcast. A PVR may be constantly recording, and generally store several hours of content in the hard drive. Thus, for example, when the viewer may walk into the room 10 minutes into a live broadcast movie, the viewer may be able to rewind the PVR by 10 minutes and catch the beginning since the movie may be stored in the hard disk of the PVR.

A problem which exists for a PVR lies in the limitation of its hard disk capacity. For example, if a PVR has a 30 gigabyte hard disk, the hard disk may store up to 30 hours of content. Thus, in this example, the viewer may have to expand the hard disk capacity if the viewer wants to keep more than 30 hours of content in the PVR device. One of the examples of expanding the hard disk capacity may be adding more hard disks (two 30 gigabyte hard disks for 60 hours). Another example of expanding the hard disk capacity may be replacing the existing hard disk with a hard disk with additional storage capacity. However, adding an additional hard disk or replacing the existing hard disk may be very difficult since broadcast programs are hard-wired into the PVR device (broadcast programs are stored in a hard disk that talks with other processing units of the PVR device). Further, it may be costly for the viewer to purchase another hard disk or an additional hard disk.

Consequently, it would be advantageous if a method existed which maximizes space on the hard disk efficiently. It would also be advantageous if a viewer could have a choice to delete unwanted contents automatically in order to regain available space on the hard disk, or to save his/her own version of the program. It would be also advantageous if the operation of optimally storing space on the hard disk does not overburden the PVR device.

### SUMMARY OF THE INVENTION

Accordingly, the present invention is directed to a method of increasing available space on the hard disk of a PVR by furnishing a viewer with automated content deletion capacity. A PVR may employ a database table (scene segment database table) as a program is recorded on the hard disk. In an advantageous aspect of the present invention, the user preference information for each scene segment may be stored in the database table in which the recording area on the hard disk is maintained efficiently. The user may delete the unwanted scenes automatically by deleting the associated database tables but the actual scene segments stored on the hard disk may not need to be deleted. In this way, the PVR system may not be overburden by frequent deletion operations and may have more available space on the hard disk for the future recording of the broadcast program.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic block diagram illustrating an exemplary PVR device in accordance with the present invention;

FIG. 2 depicts an embodiment of a scene segment record of a database table in accordance with the present invention;

FIG. 3 is an examplary database table and hard disk wherein the viewer preferences of broadcast programs may be reflected;

FIG. 4 is an examplary database table and hard disk, subsequently to the database table and the hard disk shown in FIG. 3, wherein the viewer may choose to delete the skipped scenes;

FIG. 5 depicts an exemplary flow chart describing the steps necessary to build a database table in accordance with user preference wherein the user preferences are supplied via the user interface;

FIG. 6 depicts an exemplary flow chart describing the steps to perform a skipped segment operation in accordance with the present invention;

FIG. 7 depicts an exemplary flow chart describing the steps to perform a rewind segment operation in accordance with the present invention;

FIG. 8 depicts an exemplary flow chart describing the steps to perform a stop/pause operation in accordance with the present invention; and

FIG. 9 shows a sample user menu screen interface in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

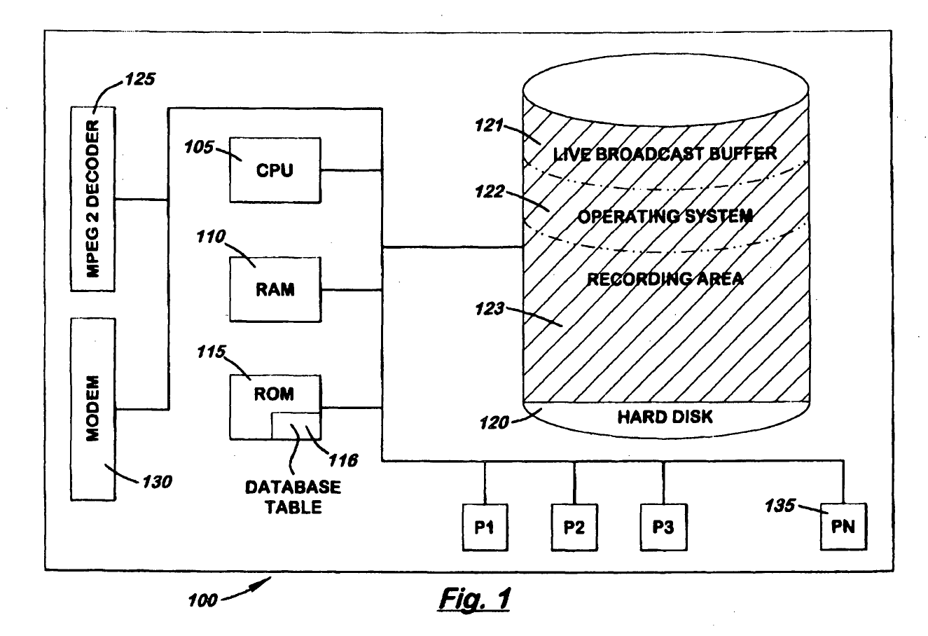

Referring to FIG. 1, a schematic block diagram illustrating an exemplary PVR device 100 in accordance with the present invention is shown. A PVR device 100 may comprise a control processing unit (CPU) 105, a Dynamic Random Access Memory (DRAM) 110, a Read Only Memory (ROM) 115, and a hard disk 120. A hard disk 120 may contain a buffer area 121 for a live broadcast, an area for storing an operating system 122, an area for recording broadcast programs 123. Further, the PVR device 100 may also include conventional components such as a modem 130 for communicating over a telephone line, for example, to a server that furnishes TV schedule information, a Moving Pictures Expert Group (MPEG) 2 Decoder 125 and several processors 135 for the operation of the PVR device. In an embodiment of the invention, the PVR may include different kinds of encoding/decoding devices, output connections, serial link modules, user input modules and the like.

The PVR may be capable of receiving broadcast programs and generating a record data stream representing the broadcast program. Initially, the broadcast program is transmitted by a provider. The broadcast program may be transmitted through different technologies, for example the broadcast may be from a cable television provider, from a satellite broadcast provider, from traditional over the air television signal provider, from a downloadable broadcast provider and the like. Additionally, the PVR may be capable of receiving instructions from a user via a user interface device. An example of the user interface device may be a remote control. Another example of the user interface device may be the key board of the host computer equipped with the PVR device. In an embodiment of the invention, the PVR may generate the associated database table while the PVR is storing the broadcast program to the hard disk.

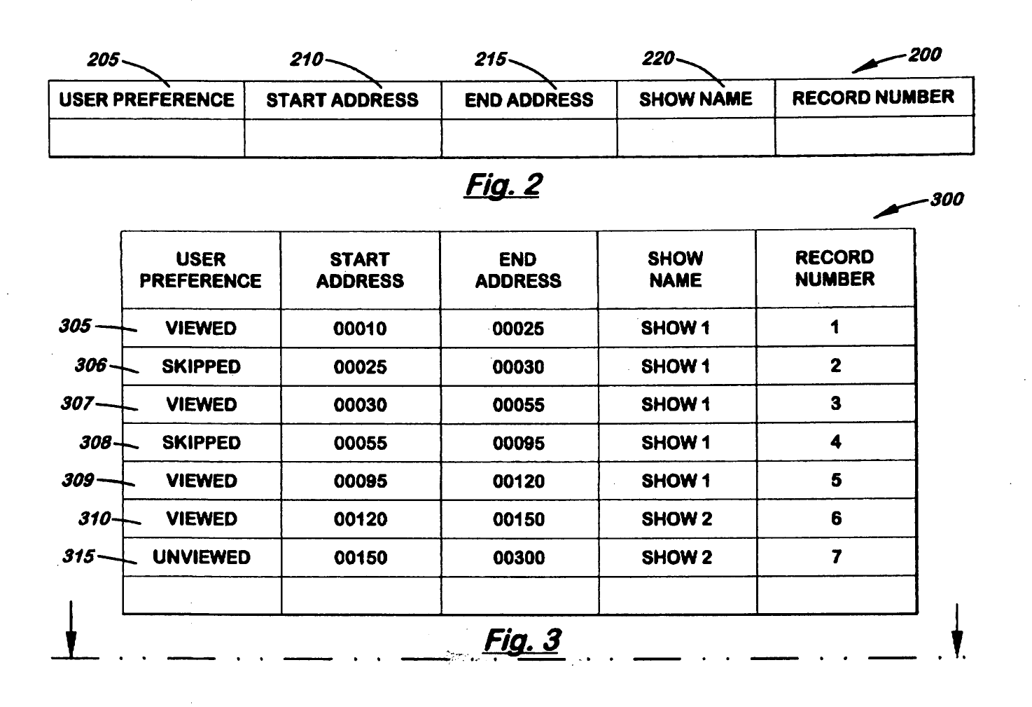

Referring now to FIG. 2, an embodiment of a database table record 200 in accordance with the present invention is shown.

The database table 200 may contain user preference data of each scene segment (a portion of content, such as a portion of a broadcast program) in order for the system to playback the broadcast program selectively. The recorded broadcast program may be divided into several scene segments on the hard disk. This division may be done virtually based on the user's reaction to the broadcast program. For example, if the user watches an entire show without any intervention, there may be one viewed scene segment stored on the hard disk. On the other hand, if a user skips two commercials during the broadcast program, there may be 5 scene segments on the hard disk with three viewed segments and two skipped segments. In the present embodiment, the database table record 200 may contain a start address field 210 (storing the starting position of the scene segment in the hard disk), an end address field 215 (storing the ending position of the segment in the hard disk), a show name field 220, a user preference field 205, and extra fields.

The user preference may be supplied via a user interface device to the CPU of the PVR device. In the present embodiment, there may be at least three types of user preferences including “skipped”, “viewed”, and “unviewed”. For example, a typical remote control may have a play, a fast-forward, a stop/pause, and a rewind button. If the user presses the play button of the remote control, the user preference for the scene segment may be recognized as “viewed.” If the user presses the fast forward (FF) button of the remote control, the user preference for the scene segment may be recognized as “skipped.” If the user presses the pause button, the user preference for the scene segment may be recognized the “unviewed.”

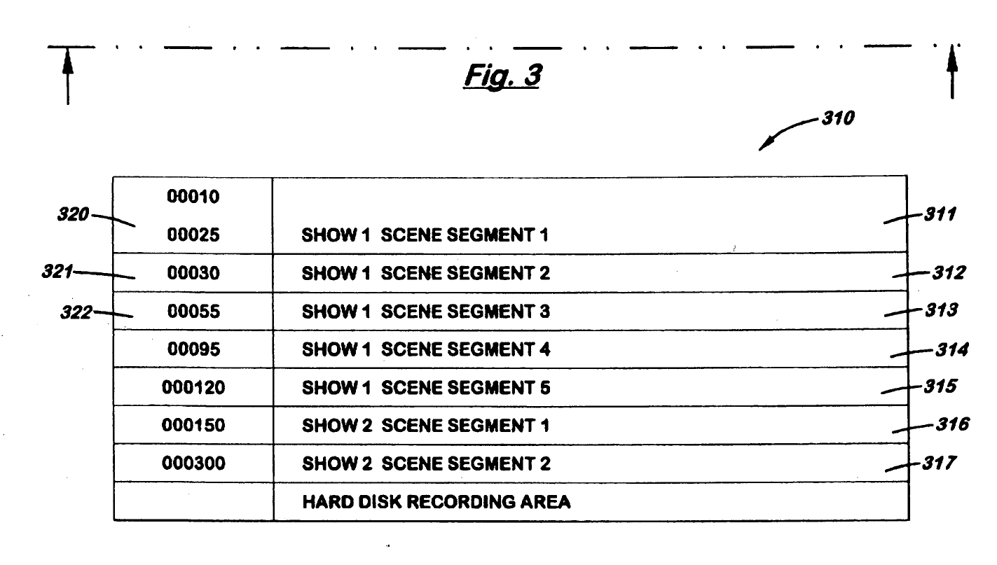

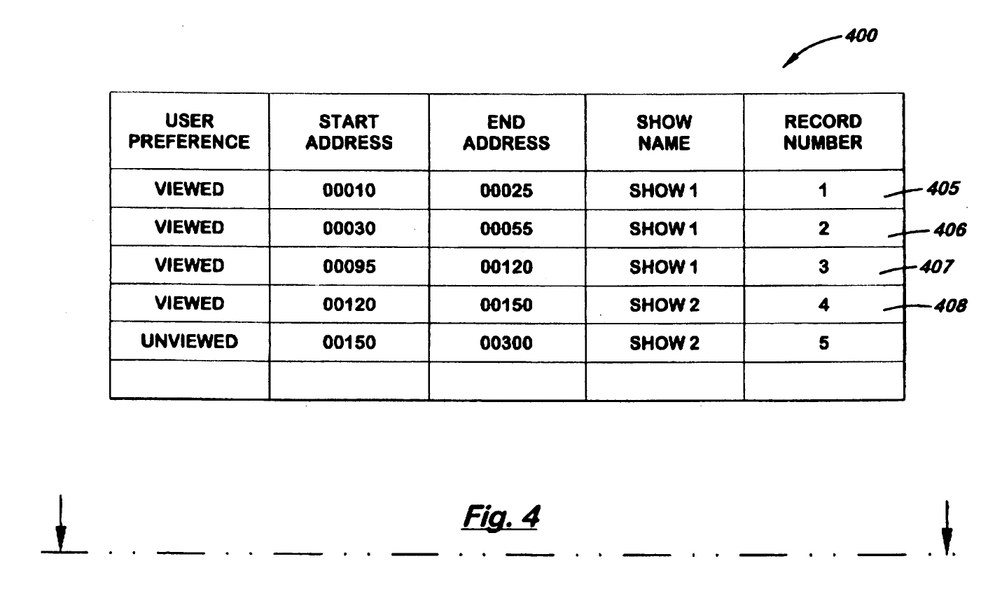

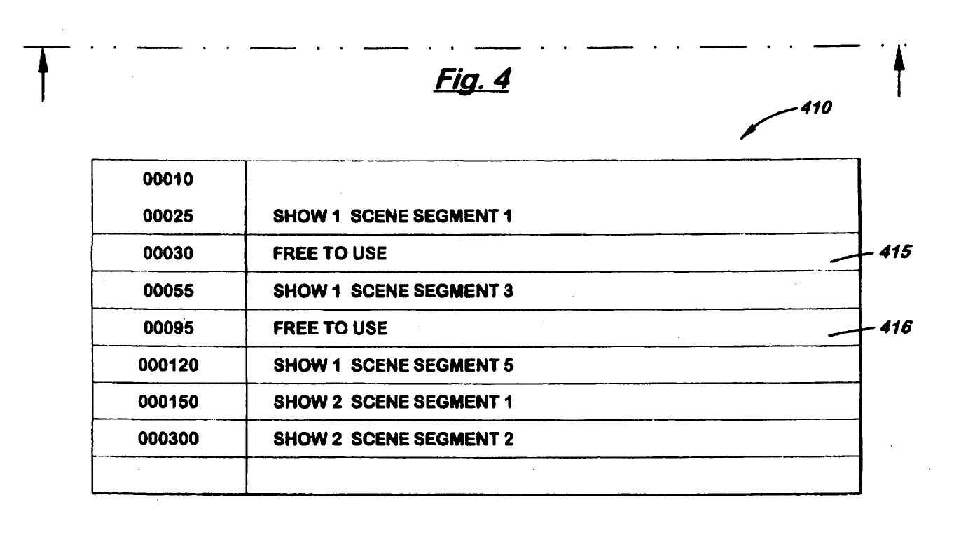

In the present embodiment, FIGS. 3 to 4 sequentially show a sample database table of scene segments and recording area on the hard disk storing the scene segments wherein a user chooses to delete skipped scenes. As shown in FIG. 3, a database table containing user preference data 300 may be generated in accordance with the present invention. When the broadcast program is broadcast or streamed and then stored on the hard disks 310 as a series of scene segments 311-317, associated database records 305-315 may be generated and stored in the database table 300 based on the user preferences. Each database record 305-315 characterizes individual scene segment 311-317 in accordance with the user preference signals determined by the user's reaction (user input) to the program. The user preference signals may be supplied through a user interface such as a remote control. The database table 300 may be stored in a storage medium of the PVR such as hard disk, ROM or the like. When the user watches a pre-recorded broadcast program (playback), previously built database table may be updated if there are new user inputs (preferences).

Database records 305-315 may store the starting address and the ending address of individual scene segments on the hard disk. For example, when the user starts a broadcast program, a viewed record 305 may be created with “viewed” user preference and the name of the broadcast program. Since an address is a specification of a location in the hard disk, the system may retrieve the address of the physical location 320 of the scene segment 311 stored in the hard disk 310. Alternatively, the system may retrieve the address of the logical location of the scene segment stored in the hard disk. The starting address 320 of the scene segment 311 may be entered in the start address field of the associated viewed record 305. As a result, the start address field of the viewed record 305 may store the starting point of the scene segment 311 that the user is currently watching. When the user starts skipping scenes, for example commercial scenes, a new skipped record 306 may be created and the viewed scene segment 311 in the hard disk may be marked as ended. The ending address 321 of the viewed scene segment (current address) which may also indicate the starting address 321 of the skipped scene segment 312 will be provided for the database table 300. Then, the database table 300 may be updated accordingly. Consequently, the skipped record 306 may contain a start address of the skipped scene segment, “skipped” user preference, and the name of the broadcast program. The similar steps may be repeated for generating the data base table until the broadcast program reaches its end.

Once the scene segments for the broadcast program are stored in the hard disk and the associated database table 306 is generated, the user may manipulate the recorded program in several ways. For example, the user may delete the scenes that the user has skipped previously, may delete the whole program, may save the entire program or may watch the program again.

Referring to FIG. 4, the sample database table 400 after the system deletes skipped scenes is shown. The database table 400 may contain viewed records 405-407 for the broadcast program but may not contain skipped scene records any more. Accordingly, the hard disk area 415-416 that used to store the skipped scene segments may be available for storage of other content, thus maximizing the available storage of the hard drive. In an advantageous aspect of the present invention, the delete skipped scene operation may not involve actual deletion of the scene segments in the hard disk 410. Since the system may consult with the database table 400 to get scene segment information for a playback or to locate available spaces in the hard disk 410, the hard disk space storing skipped scene segment may not need to be actually deleted.

In an alternative embodiment of the invention, the system may perform disk space management (memory management) on a scheduled time. One of the examples of disk space management may be a garbage collection. Generally, garbage collection is a software routine that searches memory for areas of inactive data and instructions in order to reclaim available space. There may be many ways to implement garbage collection in the PVR. The PVR may provide a scheduled garbage collection menu choice for the user. For example, the system may delete all skipped scenes of pre-recorded programs periodically on every Sunday night as directed by the user. Another example may be an automated garbage collection by the system. It may be done when the system determines that the hard disk does not have enough available space for recording. Further, in order to achieve efficient disk space management, the system may perform compaction on scene segments. Compaction is a process of gathering and packing the currently allocated area of memory medium in as small a space as possible, so as to create as much continuous free space as possible. Thus, after compaction, the available space in between scene segments may be eliminated, and the scene segments are moved into a single contiguous block of memory.

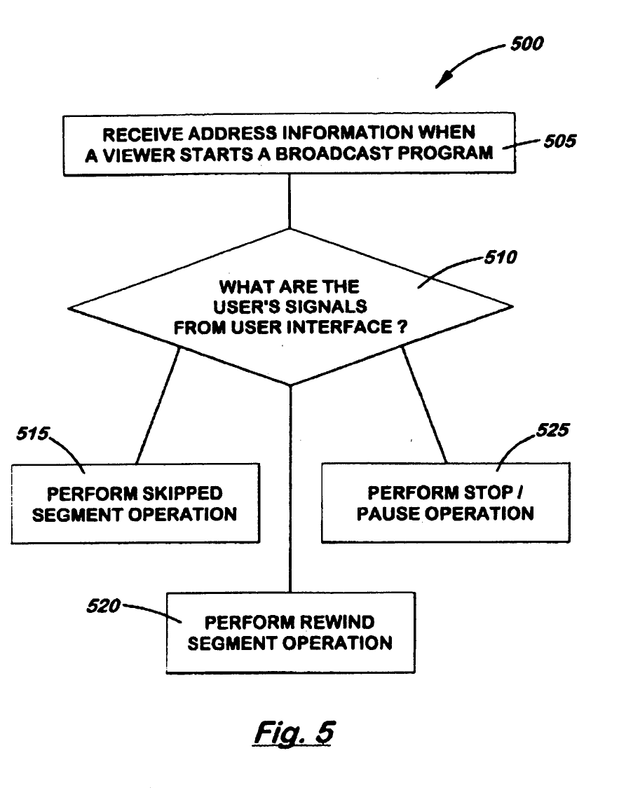

FIGS. 5 to 8 generally show exemplary processes of building a database table in accordance with user preferences.

Referring to FIG. 5, a flow chart of an exemplary process 500 for building a database table based on user preferences is shown. The process 500 may start with the step in which a user starts a broadcast program using a PVR device. An example of the broadcast program may be a live TV show. Another example of the program may include a cable broadcast, Web broadcast, a video stream (DVD movie), a multimedia broadcast, pre-recorded broadcast program or the like. Conventionally, the PVR device may provide for the recording of broadcast program and playback of broadcast program at any future time. (The playback can be almost immediately after the recording so that the devices can simulate the ‘rewind’ or the ‘pause’ function of a video tape recorder.)

In an embodiment of the invention, when the user is watching a live broadcast program, the system may keep recording the broadcast program on the hard disk and creating the associated database table. Additionally, if the user is watching a pre-recorded program (playback), the system may update the associate database table based on new user preferences if it is necessary. In an alternative embodiment of the invention, the system may employ a temporary memory area to receive a live broadcast program. For example, when the user is watching a live program, the system may record the live program on a buffer area for short period of time and may create the associated database table. If the user chooses to save the entire program, the system may copy the individual scene segments of the program from the buffer to recording area of the hard disk and update database table accordingly. The database table will contain the user preference information for future use. If the user chooses to delete the skipped scene, the system will copy only viewed scene segments to the hard disk and update the database table accordingly. If the user chooses to discard the program, the system may delete the associated database table and the buffer area is available for the next show.

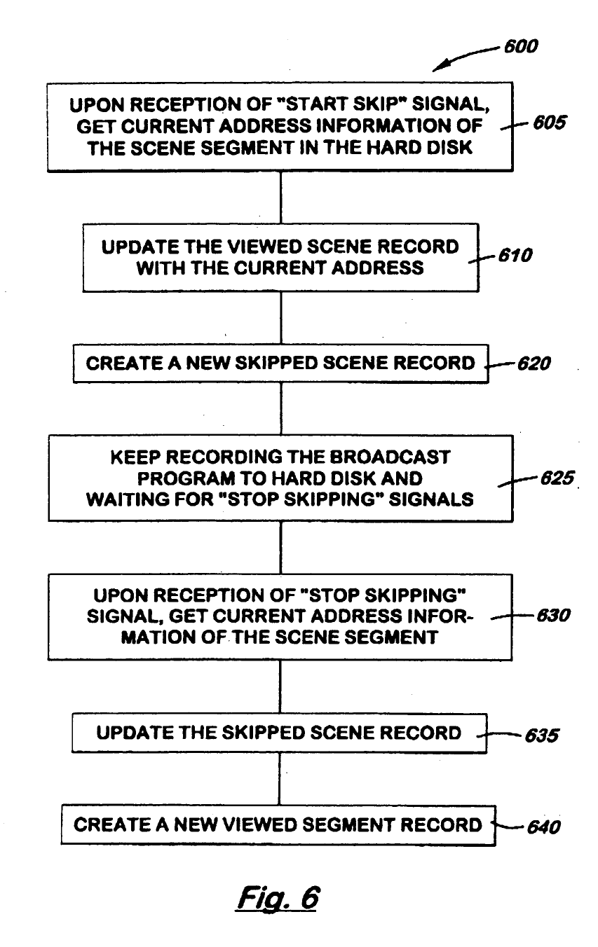

Upon reception of a “start” signal, the system may create a new viewed record for the scene segment that the user is viewing currently 505. The starting point (current address) of the scene segment stored on the hard disk will be supplied to the database table and stored in the start address field of the viewed record 505. When user changes his or her preference, the new user preference signal may be supplied via a user interface device to the system 510. For example, the user may press FF button of the remote control to skip unwanted scenes. Then, the process 500 may recognize the “start skip” signal and perform a skipped segment operation 515 as shown in FIG. 6.

FIG. 6 illustrates a process 600 to perform a skipped segment operation. The process 600 may start with the step in which the system determines whether it receives a “start skip” signal 605. Referring back to FIG. 5, the viewed record may have been newly created for the viewed scene segment 505. The ending point (current address) of the viewed scene segment stored in the hard disk will be supplied to the database table 605 and stored in the end address field of the viewed record 610.

A new skipped record may be created for the skipped scene segment (the portion of the program skipped by the user) 620. The value of the current address may be entered in the start address field of the skipped record 620. While the user skips some portion of the broadcast program, the system may keep recording the broadcast program to the hard disk 625. When the system may receive a “stop skipping” signal, the skipped scene segment may be marked ended 630 and the database table may be updated accordingly 635. For example, “stop skipping” signals may be generated when the user releases the FF button of the remote control. Upon reception of a “stop skipping” signal, the system may determine the ending point (current address) of the skipped segment on the hard disk 630. The value of the current address may be entered in the end address field of the skipped record 635. Since the user preference changes to “viewed,” a new view record may be created for the next viewed scene segment 640.

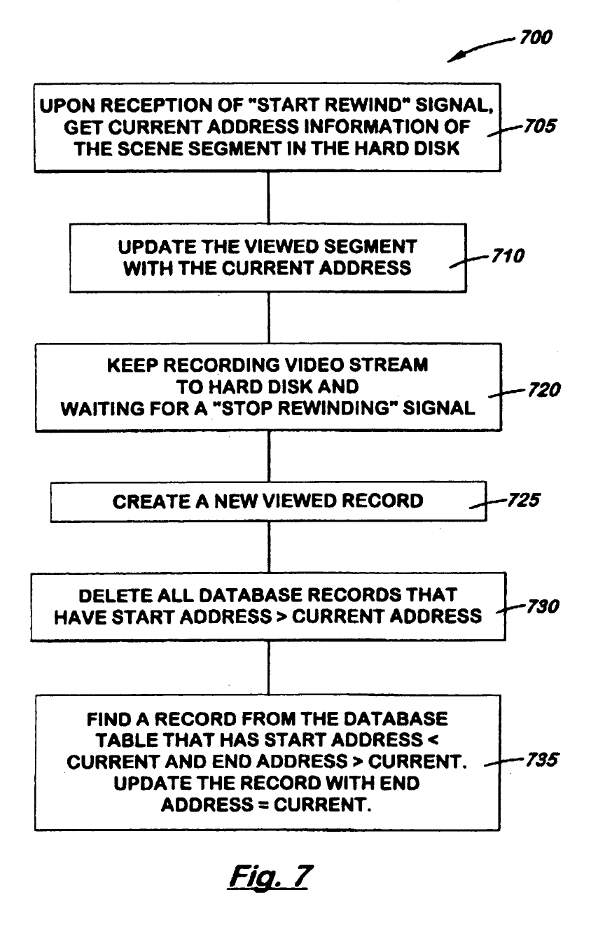

Referring back to FIG. 5, when the user changes his or her preferences, the process 500 may receive the user preference signals via a user interface device 510. For example, when the user presses the rewind button of the remote control, a “start rewind” signal may be generated. Then, the process 500 may recognize the “start rewind” signal and perform a rewind segment operation 515 as shown in FIG. 7.

FIG. 7 shows a process 700 to perform a rewind segment operation. The process 700 may start with the step in which the system determines whether it receives a “start rewind” signal 705. Referring back to FIG. 5, the viewed record may have been newly created for the viewed scene segment 505. Upon reception of a “start rewind” signal, the system may determine the ending point (current address) of the viewed scene segment in the hard disk 705 and update the end address field of the viewed record with the current address 710.

The system may be waiting for a “stop rewinding” signal from the user interface 720. For example, a “stop rewinding” signal may be generated when the user releases the RW button of the remote control. Upon reception of the “stop rewinding” signal, the system may determine the ending point (current address) of the rewound scene segment on the hard disk 725. Since the user rewinds some portion of the program, a new viewed record may be generated based on a new user preference (the user may watch the rewound portion again with different user preferences). The system may delete database records associated with rewound portion of the broadcast program 730. This may be done by comparing the current address with the start address of each record 730. The system may update the viewed record if its end address may need to change because of the new division of segment 735.

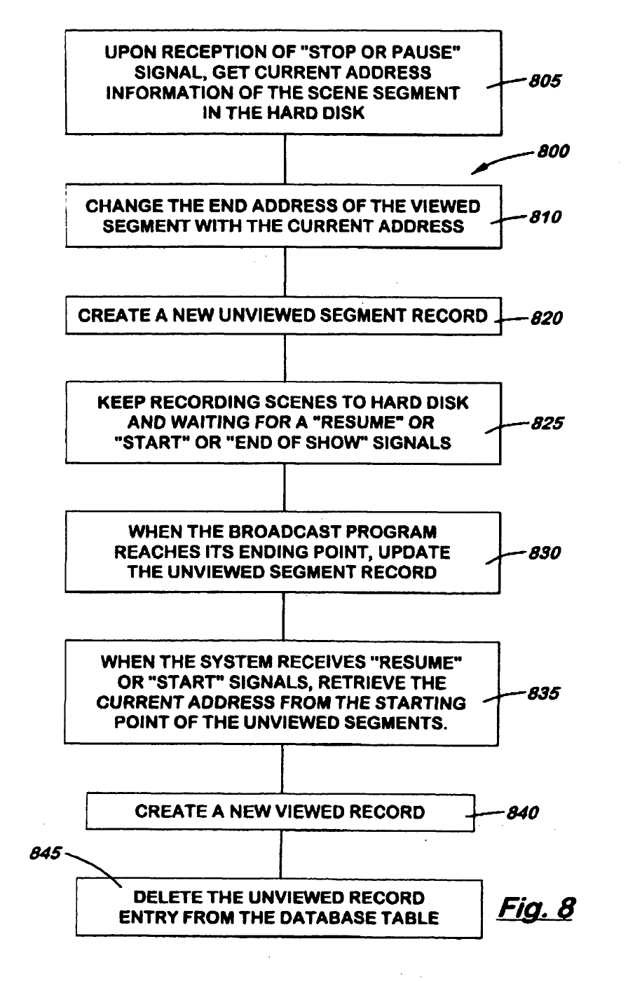

Referring back to FIG. 5, when the user changes his or her preferences, the process 500 may receive the user preference signals from a user interface device 510. For example, when the user presses a stop or a pause button of the remote control, the system may receive a “stop” or a “pause” signal via the user interface (a remote control). Then, the process 500 may recognize a “stop” or a “pause” signal and perform a stop/pause operation 515 as shown in FIG. 8.

FIG. 8 is a flowchart showing a process to perform a stop/pause operation. The process 800 may start with the step in which the system determines whether it receives a “stop” or a “pause” signal 805. Referring back to FIG. 5, the viewed record may have been created for the viewed scene segment 505. The ending point (current address) of the viewed scene segment stored in the hard disk may be supplied to the database table 805 and entered in the end address field of the viewed record 810. A new unviewed record may be created for the scene segment which the user may not have chance to view or skip. The start address field of the unviewed record may have the value of current address 820. The PVR device may keep writing the broadcast program in the hard disk after it receives a “stop” or a “pause” signal 825.

Upon reception of the “resume” or the “start” signal, the system may determine what segment the system has to play first. The system may look at the start address (current address) of the unviewed record which indicates the resuming address of the broadcast program stored on the hard disk 835. The PVR device may play the rest of the program. Since the user preference changes to “viewed,” a new viewed record for the scene segment viewed by the user may be created with the start address field containing the current address 840. The unviewed record may be deleted from the database table since the database table may be updated with new records 845.

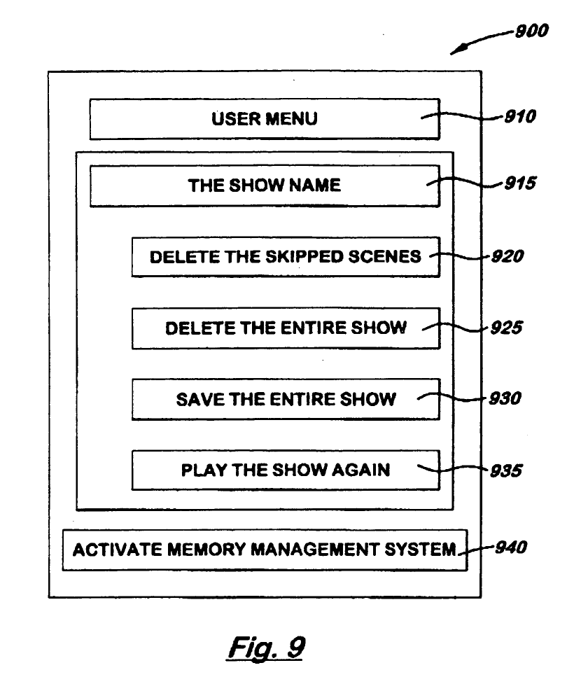

Referring to FIG. 9, a sample User Menu Screen 900 for the PVR device is shown. The PVR may be capable to receive the menu selections from the user via user interface device. Once the scene segments for the broadcast program are stored in the hard disk and the associated database table is generated, the user may manipulate the recorded program in several ways as described previously. The User Menu Screen 900 may provide several choices for the user to manipulate the broadcast program. The user may have menu choices such as Delete the Skipped Scenes 920, Delete the Entire Show 925, Save Entire Show 930, and Play the Show Again 935. The User menu may provide extra menu selections such as Memory Management (garbage collection and compaction) 940.

Although the invention has been described with a certain degree of particularity, it should be recognized that elements thereof may be altered by persons skilled in the art without departing from the spirit and scope of the invention. It is believed that the method for the present invention and many of its attendant advantages will be understood by the foregoing description, and it will be apparent that various changes may be made in the form, construction, and arrangement of the components thereof without departing from the scope and spirit of the invention or without sacrificing all of its material advantages, the form herein before described being merely an explanatory embodiment thereof. It is the intention of the following claims to encompass and include such changes.

1. A method for content recording of a personal video recorder comprising:
receiving a broadcast program;
storing said broadcast program on a hard disk;
receiving a user preference signal via a user interface;
generating an associated database table in accordance with said user preference signal, said associated database table containing a plurality of scene segment records;
employing a record of said associated database table that contains a start address field, an end address field, a user preference field, and a show name field;
providing a deletion skipped scenes capacity to said user;
deleting said plurality of scene segment records which contain information of a plurality of skipped scene segments stored on said hard disk upon reception of a user command; and
regaining an available space on said hard disk storing said plurality of skipped scene segments for future recording.

2. The method for content recording of a personal video recorder of claim 1, further comprising, determining a user preference by said user preference signal supplied through a user interface device wherein said user preference signal comprises a viewed signal, a skipped signal and an unviewed signal.

3. The method for content recording of a personal video recorder of claim 1, further comprising:
determining a starting point and an ending point of said scene segments on said hard disk based on said user preference signal; and
providing information of said starting point and said ending point of said plurality of scene segments for said associated database table wherein said plurality of scene segments are virtually divided on said hard disk.

4. The method for content recording of a personal video recorder of claim 1, further comprising:
providing a playback which allows said user to play a stored broadcast program;
consulting said user preference field in said associated database table during said payback of said stored broadcast program; and
regenerating said associated database table during said playback of said stored broadcast program when said user wants to edit said broadcast program.

5. The method for content recoding of a personal video recorder of claim 4, wherein said stored broadcast program is stored on said hard disk.

6. The method for content recording of a personal video recorder of claim 1, further comprising:
providing a rewinding capacity of said broadcast program to said user;
determining a starting point of a rewind scene segment in which said user wants to start replaying;
providing information of said starting point of said rewind scene segments for said database table; and
updating said associated database table in accordance with said user preference.

7. The method for content recording of a personal video recorder of claim 1, further comprising:
providing a deletion of said broadcast program capacity to said user;
deleting said plurality of scene segment records which contain information of a plurality of scene segments stored on said hard disk upon reception of a user command; and
regaining an available space on said hard disk storing said plurality of scene segments for future recording.

8. A system for content recording of a personal video recorder comprising:
means for receiving a broadcast program;
means for storing said broadcast program on a hard disk;
means for receiving a user preference signal via a user interface;
means for generating an associated database table in accordance with said user preference signal, said associated database table containing a plurality of scene segment records;
means for employing a record of said associated database table that contains a start address field, an end address field, a user preference field, and a show name field;
means for providing a deletion skipped scenes capacity to said user;
means for deleting said plurality of scene segment records which contain information of a plurality of skipped scene segments stored on said hard disk upon reception of a user command; and
means for regaining an available space on said hard disk storing said plurality of skipped scene segments for future recording.

9. The system for content recording of a personal video recorder of claim 8, further comprising, means for determining a user preference by said user preference signal supplied through a user interface device wherein said user preference signal comprises a viewed signal, a skipped signal and an unviewed signal.

10. The system for content recording of a personal video recorder of claim 8, further comprising:
means for determining a starting point and an ending point of said scene segments on said hard disk based on said user preference signal; and
means for providing information of said starting point and said ending point of said plurality of scene segments for said database table wherein said plurality of scene segments are virtually divided on said hard disk.

11. The system for content recording of a personal video recorder of claim 8, further comprising:
means for providing a playback which allow said user to play a stored broadcast program;
means for consulting said user preference field in said associated database table during said payback of said stored broadcast program; and
means for regenerating said associated database table during said playback of said stored broadcast program when said user wants to edit said broadcast program.

12. The system for content recoding of a personal video recorder of claim 11, wherein said stored broadcast program is stored on said hard disk before said user chooses to employ said playback.

13. The system for content recording of a personal video recorder of claim 8, further comprising:
means for providing a rewinding capacity of said broadcast program to said user;
means for determining a starting point of a rewind scene segment in which said user wants to start replaying;
means for providing information of said starting point of said rewind scene segments for said database table; and
means for updating said associated database table in accordance with said user preference.

14. The system for content recording of a personal video recorder of claim 8, further comprising:
means for providing a deletion of said broadcast program capacity to said user;
means for deleting said plurality of scene segment records which contain information of a plurality of scene segments stored on said hard disk upon reception of a user command; and
means for regaining an available space on said hard disk storing said plurality of scene segments for future recording.

15. A method for content recording of a personal video recorder comprising:
receiving a broadcast program;
storing said broadcast program on a hard disk;
receiving a user preference signal via a user interface;
generating an associated database table in accordance with said user preference signal, said associated database table containing a plurality of scene segment records;
employing a record of said associated database table that contains a start address field, an end address field, a user preference field, and a show name field;
providing a stop capacity of said broadcast to said user;
providing information of said starting point of said unviewed scene segments for said database table,
wherein said unviewed scene segment is virtually divided on said hard disk; and updating said associated database table in accordance with said user preference.

16. The method for content recording of a personal video recorder of claim 15, further comprising, determining a user preference by said user preference signal supplied through a user interface device wherein said user preference signal comprises a viewed signal, a skipped signal and an unviewed signal.

17. The method for content recording of a personal video recorder of claim 15, further comprising:
providing a playback which allows said user to play a stored broadcast program;
consulting said user preference field in said associated database table during said payback of said stored broadcast program; and
regenerating said database table during said playback of said stored broadcast program when said user wants to edit said broadcast program.

18. The method for content recoding of a personal video recorder of claim 17, wherein said stored broadcast program is stored on said hard disk.

19. The method for content recording of a personal video recorder of claim 15, further comprising:
providing a rewinding capacity of said broadcast program to said user;
determining a starting point of a rewind scene segment in which said user wants to start replaying;
providing information of said starting point of said rewind scene segments for said database table; and
updating said associated database table in accordance with said user preference.

20. A system for content recording of a personal video recorder comprising:
means for receiving a broadcast program;
means for storing said broadcast program on a hard disk;
means for receiving a user preference signal via a user interface;
means for generating an associated database table in accordance with said user preference signal, said associated database table containing a plurality of scene segment records;
means for employing a record of said associated database table that contains a start address field, an end address field, a user preference field, and a show name field;
means for providing a stop capacity of said broadcast to said user;
means for providing information of a starting point of a unviewed scene segments for said database table; and
means for updating said associated database table in accordance with said user preference,
wherein said unviewed scene segment is virtually divided on said hard disk.

21. The system for content recording of a personal video recorder of claim 20, further comprising, means for determining a user preference by said user preference signal supplied via a user interface device wherein said user preference signal comprises a viewed signal, a skipped signal and an unviewed signal.

22. The system for content recording of a personal video recorder of claim 20, further comprising:
means for providing a playback which allows said user to play a stored broadcast program;
means for consulting said user preference field in said associated database table during said payback of said stored broadcast program; and
means for regenerating said database table during said playback of said stored broadcast program when said user wants to edit said broadcast program.

23. The system for content recoding of a personal video recorder of claim 22, wherein said stored broadcast program is stored on said hard disk.

24. The system for content recording of a personal video recorder of claim 20, further comprising:
means for providing a rewinding capacity of said broadcast program to said user;
means for determining a starting point of a rewind scene segment in which said user wants to start replaying;
means for providing information of said starting point of said rewind scene segments for said database table; and
means for updating said associated database table in accordance with said user preference.
